(19) United States
(12) Patent Application Publication
(10) Pub. No.: US 2013/0034447 A1
(43) Pub. Date: Feb. 7, 2013

(54) WIND TURBINE BLADE HAVING AN OUTER SURFACE WITH IMPROVED PROPERTIES

(71) Applicants: Pontus Nordin, Linkoping (SE); Göte Strindberg, Linkoping (SE)

(72) Inventors: Pontus Nordin, Linkoping (SE); Göte Strindberg, Linkoping (SE)

(73) Assignee: Saab AB, Linköping (SE)

(21) Appl. No.: 13/522,349

(22) PCT Filed: Jan. 14, 2010
(86) PCT No.: PCT/SE2010/050031

§ 371 Date: Oct. 9, 2012

(51) Int. Cl. F03D 11/00

(52) U.S. Cl. 416/230; 416/241 R

(57) ABSTRACT

A wind turbine blade including an outer surface that serves as an aerodynamic surface when the blade is subjected for an air stream. A resin matrix made of a laminate of at least one ply includes the outer surface. The outer ply includes a nano structure embedded therein such that the filaments of the nano structure in the ply have essentially the same angular orientation relative a plane of the outer surface.

### TECHNICAL FIELD

The present invention relates to a wind turbine blade comprising an outer surface, which serves as an aerodynamic surface when the article's outer surface is subjected for an air stream, according to the preamble of claim 1.

The invention primarily regards wind turbine blades manufactured by composite manufacturers within the industry of wind turbines, wherein the wind turbine blade is designed with an aerodynamic surface.

### BACKGROUND ART

Components, such as composite airframe structures of the type wind turbine blade having aerodynamic function, are designed and manufactured with a certain surface texture/roughness, allowable steps, gaps and waviness which affect airflow over the wind turbine blade's skin surface (i.e. the outer surface). The materials—and manufacturing technology used today producing such surface roughment limits the aerodynamic efficiency of the wind power station.

This situation is not improved by the current standard procedure to apply a coating (paint layer) on the airframe to provide a smooth protective skin surface.

The wind turbine blade's skin outer surface is also prone to surface defects as a consequence of for example cure shrinkage of the polymeric material during the manufacture of the wind turbine blade and the skin outer surface may also be exposed to impacts and damage during use of the wind turbine blade.

Different types of wind turbine blade skin coating exist today, such as paint coatings having strength properties, paint systems for protecting and maintaining the smoothness of the outer surface thereby promoting the aerodynamic performance of the wind turbine blade during use.

Today, research and development efforts are present within the wind power plant industry to produce more efficient wind power stations. One solution is to develop the generators of the wind power plants so that they are more efficient. Another possible solution, addressed in this invention, is to improve the aerodynamic efficiency of the wind turbine blade.

Current technology wind turbine blade components made from aluminum, carbon fiber composites, ceramics and other materials with existing manufacturing methods suffer from a significant surface roughness, steps, gaps and waviness etc. due to insufficient manufacturing methods, and operational use (rain and sand erosion etc).

Regarding a polymer-based fiber composite aerodynamic surface, such as a wind turbine blade skin, the outer surface layer consists of un-reinforced plastic material, typically covered by a layer of paint. This surface layer will result in a significant surface roughness due to several contributing effects, e.g cure shrinkage of the polymeric material, uneven distribution of resin in the surface layer (resin-rich areas) and different thermal elongation of surface material. Currently used technology also results in a surface layer having an outer surface, which is prone to surface defects during manufacturing of the component, damage due to erosion during service and other characteristics which shorten the service life of the wind turbine blade surface and (primary concern) reduce the aerodynamic efficiency. The described drawbacks of currently used technology are also valid for all types of aerodynamic airframe components such as winglets of the wind turbine blade etc.

Nano structure technology (such as nano fibres/tubes in polymeric materials) is an emerging technology of interest to the wind power composite industry. This is due to the high strength and stiffness, as well as other properties such as low thermal elongation, of the nano fibres/tubes embedded in the polymeric material.

WO 2008/070151 discloses a wind power station tower comprising nano tube resin of the rotor blades.

It is desirable in an effective manner to provide and maintain the smoothness of the wind turbine blade's outer surface of the laminate during the manufacture of the laminate. It is also desirable to maintain the smoothness of the outer surface during the service and/or use of the wind turbine blade. It would thus be beneficial for the aerodynamic efficiency of the wind turbine blade if the outer surface were smooth during the whole service life, thereby promoting an efficient wind power station with long life duration.

It is further desirable to provide a wind turbine blade which is cost-effective to produce, which wind turbine blade per se is resistant against damages on the outer surface during the production, and which wind turbine blade has an outer surface which is hard, smooth and form stable.

An object is to minimize the maintenance cost for a wind turbine blade, at the same time as an improved efficiency is achieved regarding the action the wind power station.

A further object is also to eliminate drawbacks of known techniques and improve the properties of the article by an effective production.

### SUMMARY OF THE INVENTION

This has been achieved by the wind turbine blade defined in the introduction being characterized by the features of the characterizing part of claim 1.

In such way a wind turbine blade is achieved with improved properties (being discussed in the introduction). By a unidirectional orientation of the nano filaments an efficient production of the laminate will be provided. This can be achieved by an upper ply in the form of a nano structure mat being embedded in the resin and having filaments with a random orientation in a plane such that the filaments are parallel with the plane of the upper surface. The production includes a step of introducing a resin (used as a matrix for embedding the nano filaments) into a mat of nano filaments or between separate unidirectional nano filaments. The extending—in two dimensions or in one dimension—nano filaments are thus arranged parallel to each other for optimal resin fill out during the production of the laminate. The introduction of resin will have not be obstructed or hindered and the resin will fill out all air spaces between the nano filaments. Thereby the outer surface will be smooth and hard and form stable.

Thereby is provided materials and methods for design and manufacturing of aerodynamic surfaces which are far more perfect in shape and surface quality than existing technology surfaces. These improved quality surfaces support the introduction of laminar flow wind turbine blade components to a greater extent than possible with existing technology surfaces.

In such way is achieved that the wind turbine blade's outer surface (aerodynamic surface) is near perfect regarding shape and surface quality as well as more damage tolerant, durable and hard compared to existing technology surfaces. Eventual cure shrinkage of the resin in the different plies during manufacture of the wind turbine blade,—and eventual uneven distribution of resin in the outer ply and different thermal elongation in the outer ply or plies during the manufacture-, will thereby not affect the smoothness of the skin surface since the nano structure, embedded in the outer ply/plies, will make the outer surface hard holding back eventual cure shrinkage forces. The resin matrix of the laminate will have no air pockets or uneven distribution of resin, which is achieved by that the filaments in the ply have the same orientation relative the plane of the outer surface of the laminate, wherein the resin during manufacture of the laminate will effectively fill the gaps between the nano filaments.

By forming the wind turbine blade of a laminate of plies, each ply having a specific fibre orientation so that the plies together make the wind turbine blade structural, and the outer ply is provided with the nano structure, the wind turbine blade will thus have an aerodynamic surface which is smooth and hard. The wind turbine blade is thus resistant to cracks in the outer surface and also resistant to erosion during its use. The present solution will thus result in a smooth outer surface having a long life, which is energy saving and efficient.

Alternatively, the outer ply comprises a nano structure embedded therein in such way that the nano filaments of the nano structure in the ply have the same angular orientation relative the plane of the outer surface, which means that the nano filaments can be oriented parallel coplanar or in parallel planes or that the nano filaments can have different orientations in at least one plane but with an extension parallel or with an angle relative said plane.

Alternatively, at least a portion of the nano structure is exposed in the outer surface.

The nano structure partly exposed in the outer surface of the wind turbine blade and being embedded in the outer ply gives an effect that the outer ply is compatible regarding the thermal elongation with both glass fibre reinforced plastics (GFRP) and carbon fibre reinforced plastic (CFRP) structures. A common outer surface film or ply (such as ordinary paint) of today, for increasing the laminar flow, has often no reinforcements which makes it is less compatible with GFRP and CFRP due to a higher thermal expansion of the outer ply, which may cause debonding, cracks etc.

The nano structure's filaments are each comprised of an extended nano filament including a first and a second end. The nano structure is suitably partly exposed in the outer surface such that a part of the nano structure comprises first ends exposed in the outer surface.

The nano structure may be comprised of carbon nano tubes, carbon nano fibres, carbon nano wires etc.

In addition to aerodynamically efficient surface coatings of constant or near-constant thickness, CNT-reinforced surface materials can alternatively also be applied as textured or micro-structured surface layer, so called riblets. The riblet technology is based on existing knowledge, but CNT-reinforced materials can be used to realize this kind of surface texture with a durable, smooth outer surface. This is realized by afore mentioned improved material properties, such as erosion resistance, hardness, pattern accuracy, stiffness and other functional properties resulting from use of CNT as the reinforcing material.

In such way the outer surface of a coating is achieved improving the aerodynamic properties of the wind turbine blade, e.g. enhancing the efficiency, etc. The nano structure of the coating can be applied on a portion or on all portions of the wind turbine blade, also in areas where mechanical fasteners are used in order to cover these fasteners and reduce the negative aerodynamic effects of having mechanical fasteners in laminar flow areas.

Suitably, the outer ply is a ply of a laminate comprising at least two plies, wherein each ply comprises large fibres (such as carbon or glass fibres) having a fibre orientation different from—or identical with—the fibre orientation of large fibres of an adjacent ply.

In such way, eventual cure shrinkage of the resin in different plies during manufacture of the laminate due to eventual uneven distribution of resin and different thermal elongation in the plies during the manufacture of the wind turbine blade shell, will thereby not affect the smoothness of the outer surface.

Preferably, the nano structure is so dense within the outer ply so that it will be as hard as possible, but not so dense that the electric conductivity ceases.

Thereby the hard and smooth aerodynamic surface is suitable to use as a lightning protection for the wind turbine blade. The design of an efficient system for lightning protection functions, containing the conductive nano structure, should be based on the fact that both the electrical conductivity of a bulk material, e.g. a polymer, using these fillers, will vary with the filler content. The electrical conductivity of such a system can for instance increase or decrease with the CNT filler content, depending on specific conditions.

Alternatively, the nano structure is positioned within the area of the blade tip.

In such way the wind power station can be used more silent, since higher speeds are due regarding the blade tips. A laminar airflow can thus be created at a position where the speed is highest, wherein the lack of turbulence provides a silent operation. Such a wind turbine blade is cost-effective to produce.

Alternatively, the nano structure's filaments are oriented transverse to the plane of the outer surface.

In such way the mechanical strength of the wind turbine blade is improved in a direction transverse (z-direction) to the plane of the laminate. Thereby an additional strength is achieved for the laminate complementing the strength of the large fibres extending parallel with the extension of the plane of the laminate.

Suitably, the nano structure's filaments are oriented leaning relative the plane of the outer surface.

In such way the nano structure both contributes to reinforcement in z-direction and promotes for electric conductivity beneficial for the lightning protection.

Preferably, the nano structure's filaments are oriented parallel with the plane of the outer surface.

In such way the electrical conductivity can be made optimal at the same time as the eventual exposed nano filaments (i.e. a section of a filament extending from the first end to the second end of the filaments may be exposed) of the nano structure in the outer surface contribute to a hardness of the outer surface providing a long-life smoothness, thereby promoting an efficient wind power station.

Alternatively, the nano structure comprises carbon nano tubes.

Thereby a well-defined nano structure is achieved for the outer surface having an optimal mechanical strength and other properties (stiffness, thermal expansion et cetera) of importance for the application. The well-defined dimensions of the carbon nano tubes promotes for a nano structure layer which can be as thin as possible.

Preferably, the nano filament (CNT, nano fibre, nano multi wall filament, nano double wall filament, nano wire etc.) has a length of 0.125 mm or less. This is suitable for a common pre-preg ply having a thickness of 0.125 mm used in the production of aircrafts. If leaning, or in the plane oriented nano filaments are used, the length preferably can be longer. The definition of nano means that a filament particle has at least one dimension not more than 200 nm. 1 nm (nanometre) is defined as 10 metre (0,000 000 001 meter). Preferably, the diameter of a multiwall nano tube is 15-35 nm, suitably 18-22 nm. Suitably, the diameter of a single wall nano tube is 1.2-1.7 nm, preferably 1.35-1.45 nm.

Suitably, the carbon nano tubes are in shape of forest mats of aligned carbon nano tubes.

The CNT (carbon nano tube) can be produced by emerging CNT technology resulting in grown forests of CNT for high efficiency. It is known that CNT can be grown in the shape of “forests” (mats of aligned CNT's) with vertical, tilted or horizontally arranged nano tubes. Combinations of these arrangements are also possible, e.g. as two or more separate layers stacked on top of each other. It is also possible to grow CNT's as well-defined patterns, suited for the intended application. The term CNT in this application includes all types of carbon nano tubes. These can be single-wall, double-wall or multi-wall nano tubes. In addition, CNT-like materials like graphene, graphone and similar carbon-based materials with suitable electrical properties can be used. This includes single or multiple layers arranged in the plane of the outer surface or placed at a suitable angle to this plane. CNT's and similar materials as described above have a very good electrical conductivity and are therefore very suited for the lightning protection function of the article.

### BRIEF DESCRIPTION OF THE DRAWINGS

The present invention will now be described by way of examples with references to the accompanying schematic drawings, of which:

FIG. 1 illustrates a cross-section of a wind turbine blade comprising resin matrix with an outer ply comprising a nano structure exposed in the outer surface;

FIGS. 2a-2g illustrate cross-sectional portions of outer surface coatings according to various applications;

FIG. 3 illustrates a cross-section of a portion of a wind turbine blade comprising a lightning protective outer surface;

FIG. 4 illustrates an enlarged portion of the outer surface in FIG. 3 from above;

FIG. 5 illustrates a cross-section of leaning CNT's grown as “forests” directly from large fibres of an upper ply;

FIG. 6 illustrates a wind turbine blade;

FIGS. 7a-7b illustrate an outer surface comprising nano fibres;

FIG. 8a illustrates in a perspective view a section of transverse (in z-direction) oriented CNT's being exposed in the outer surface of an article;

FIG. 8b illustrates a cross-section of the article in FIG. 8a;

FIG. 9a-9b illustrate an embodiment of a wind turbine blade;

FIG. 10 illustrates a laminate comprising the reinforced outer surface and a nano structure reinforced layer in the underside of the laminate for avoiding a so called spring back-effect during production of the laminate;

FIG. 11a illustrates a prior art laminate; and

FIG. 11b illustrates a laminate according to a further embodiment of the invention.

### DETAILED DESCRIPTION

Hereinafter, embodiments of the present invention will be described in detail with reference to the accompanying drawings, wherein for the sake of clarity and understanding of the invention some details of no importance are deleted from the drawings. Also, the illustrative drawings show nano structures of different types, being illustrated extremely exaggerated and schematically for the understanding of the invention. The conductive nano structures are illustrated exaggerated in the figures also for the sake of understanding of the orientation and the alignment of the conductive nano filaments.

FIG. 1 illustrates a cross-section of a composite wind turbine blade structure 1 having an aerodynamic function.

A wind turbine blade shell 3 is made of a resin matrix, which comprises a laminate 5 of plies 7. Each ply 7 comprises fibres 9 (in the present application also called large fibres or traditional laminate reinforcing fibres) having an orientation different from—or identical with—the large fibre orientation of an adjacent ply (the diameter of the large fibre is approximately 6-8 micro metres). An outer ply P1 of the laminate 5 forms an outer surface 11. The outer ply P1 comprises large fibres 9 oriented parallel with the outer surface 11 in a first direction, and the second ply P2 beneath the outer ply P1 comprises large fibres 9 also parallel arranged with the outer surface 11, but with 90 degrees direction relative the first direction. A next layer P3 comprises large fibres 9 with 45 degrees direction relative the first direction.

The wind turbine blade's outer surface 11, which serves as an aerodynamic surface when the wind turbine blade structure 1 is subjected for an air stream a, is arranged with a nano structure 13 comprising carbon nano tubes (CNT's) 15.

The CNT's 15 are embedded in the upper ply P1 in such way that at least a portion of the nano structure 13 is exposed in the outer surface 11.

The CNT's 15 are essentially oriented transverse relative the plane P of the outer surface 11 with one end of the majority of the CNT's 15 being exposed in the outer surface 11. The other ends of the CNT's 15 are directed towards the large fibres 9, but not in contact with these. The CNT-reinforced surface layer comprising the outer surface 11 is thus integrated in the lay-up (lay-up of pre-preg plies P1, P2, P3, etc., forming the laminate 5 after curing) and therefore integrated in the curing of the wind turbine blade structure 1.

In such way the outer surface 11 of the wind turbine blade shell 3 will be smooth over a long period of time. The smoothness is achieved by the exposed carbon nano tubes CNT's 15 embedded in the upper ply P1. The orientation of unidirectional CNT's 15 provides that resin for embedding the CNT's will fill all spaces between the CNT's 15 in the laminate during the production of the laminate. The wind turbine blade structure 1 is thus cost-effective, and otherwise possible, to produce, achieving a wind turbine blade with an aerodynamic surface that fulfils the requirements, even at high speed, for laminar flow. The addition of CNT's 15 (single- or multiwall carbon nano tubes and/or other nano-sized additives with similar function) in this outer ply P1 (outer layer) results in significant improvement of the texture/smoothness of the outer surface 11, in combination with improved hardness and erosion resistance of the same. This is due to the nano-sized reinforcement by the CNT's 15, which reinforcement prevents the otherwise characteristic surface roughness during forming of the outer surface 11 in a forming tool (not shown). The outer surface 11 will be hard and improves erosion resistance associated with thermoset polymeric material. The CNT-reinforced outer surface 11 is thus integrated with the composite airframe structure 1 made of polymeric composite comprising several plies P1, P2, P3, etc.

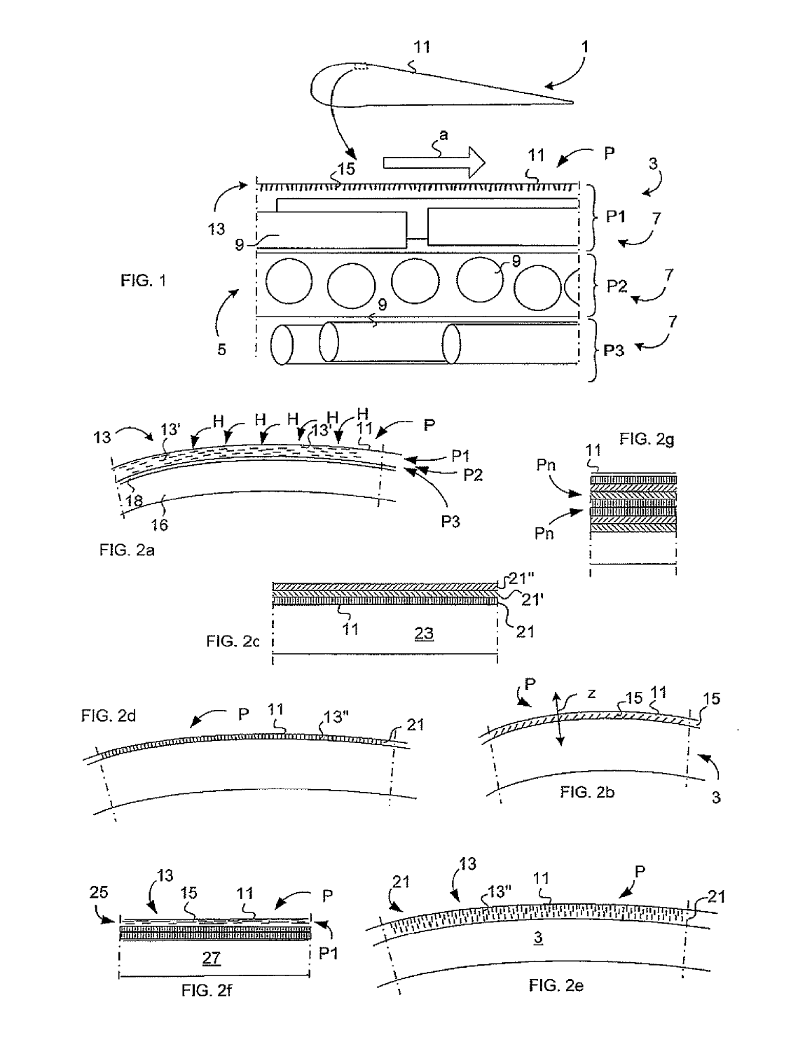

FIG. 2a schematically illustrates a portion of a wind turbine blade comprising outer plies P1, P2, P3 comprising horizontal nano filaments 13′ (parallelly extending with the plane P of the outer surface 11). The upper ply P1 is a coating covering the wind turbine blade structure and comprises the nano structure 13 embedded therein in such way that at least a portion of the nano structure 13 is exposed in the outer surface 11, i.e. a portion of the nano filaments 13′ is exposed for making the hard outer surface 11, thus maintaining the smoothness of the outer surface 11 over long time for promoting laminar airflow over the outer surface 11 during use and thus an efficient wind power station is achieved.

The plies P1, P2, P3 are in this example applied to the exterior of an existing, already manufactured and assembled wind turbine blade structure. The application is made by means of adhesive bonding 18. The smoothness of the outer surface 11 is achieved by the exposed nano structure 13 at markings H. This kind of nano-reinforced plies P1, P2, P3 of a composite skin laminate may be used as topcoat.

FIG. 2b schematically illustrates a single upper pre-preg layer used for achieving the hard and smooth outer surface 11, wherein CNT's 15 are arranged leaning relative the outer surface 11 and are embedded in the upper pre-preg layer and have an orientation relative the outer surface 11 with essentially the same angle.

In such way a wind turbine blade is achieved with improved properties, such as smoothness, hardness, form stable laminate etc. for promoting an optimal aerodynamic surface. By the unidirectional orientation of the nano filaments an efficient production of the laminate will be provided. The production means that a resin (used as a resin matrix embedding the nano filaments) flowing between CNT's 15 will have no hindrance and the resin will fill out all air spaces between the CNT's 15. Thereby the outer surface 11 will be smooth and hard and form stable.

By this embodiment the CNT-structure also contributes to reinforcement in z-direction z (against forces and strikes acting perpendicular on the outer surface 11) and at the same time promotes for electric conductivity beneficial for lightning protection, wherein the current of the strike propagates in a direction parallel with the plane P of the outer surface 11, wherein the interior of the wind turbine blade will be protected.

FIG. 2c schematically shows a precured surface layer 21 (or outer ply) applied in a curing tool 23 before curing. The precured surface layer 21 comprises an outer surface 11 facing the tool's 23 forming surface. The precured surface layer 21 comprises further two CNT-reinforced sub-layers 21′, 21″, each being nano structure reinforced in a specific direction corresponding with the nano filaments unidirectional orientation. Thereby a multidirectional reinforcement is achieved for the precured surface layer 21 per se. By the unidirectional orientation of the nano filaments in each layer 21, 21′, 21″ an effective production of the laminate will be provided

FIG. 2d schematically in cross-section shows a portion of an wind turbine blade having an aerodynamic surface (outer surface 11). A surface layer 21 comprising transversal (perpendicular to the plane P of outer surface 11) oriented carbon nano fibres 13″, arranged in the surface layer 21 so that the carbon nano fibres 13″ are partly exposed in the outer surface 11 of the surface layer 21. Not exposed nano structure filaments in the outer surface are shown in e.g. the FIG. 2b embodiment.

FIG. 2e schematically shows an example of a surface layer 21 to be applied to a composite shell of a wind turbine blade shell 3 made of CFRP (carbon fibre reinforced plastic (CFRP) structures). The layer is positioned in a female tool prior an application of CFRP and prior a curing operation to form the outer surface 11 of the cured assembly. The surface layer 21 thus also comprises large carbon fibres (not shown) embedded in the resin, thus in addition reinforcing the structure of the shell 3. Carbon nano fibres 13″ are embedded in the surface layer 21 (the upper ply) and are essentially oriented transversally to the plane P of the outer surface 11 with one end of the majority of the CNT's 15 being at a distance from the outer surface 11. The other ends of the CNT's 15 are directed towards the large fibres 9, but not in contact with these (The FIG. 5 embodiment shows nano filaments in contact with large fibres).

FIG. 2f schematically shows an example of a coating 25 applied to a metallic wind turbine blade structure 27 as a separate coating. The coating 25 comprises random distribution of CNT's 15 in a plane parallel with the plane P of the outer surface 11 (different directions of CNT extensions along the plane P of the laminate but with CNT prolongations parallel with the plane P). The coating 25 thus comprises embedded CNT's 15 in the matrix of the upper ply P1.

The resin matrix is thus made of a laminate of one ply or coating 25, which comprises the outer surface 11. The coating 25 comprises a CNT's 15 embedded therein in such way that the filaments of the CNT structure in the coating 25 have the same orientation relative the plane P of the outer surface 11. The specific orientation of the CNT's 15 thus provides that resin for embedding the CNT's will fill all air spaces between the CNT's 15 in the laminate during the production of the laminate.

FIG. 2g schematically illustrates a laminate comprising several plies comprising nano structure filaments. Each ply Pn comprises nano filaments having the same orientation (unidirectional orientation). Each ply Pn comprises a nano filament orientation being different from the orientations of the nano filaments of the other plies. This promotes for an optimal mechanical strength providing said smoothness.

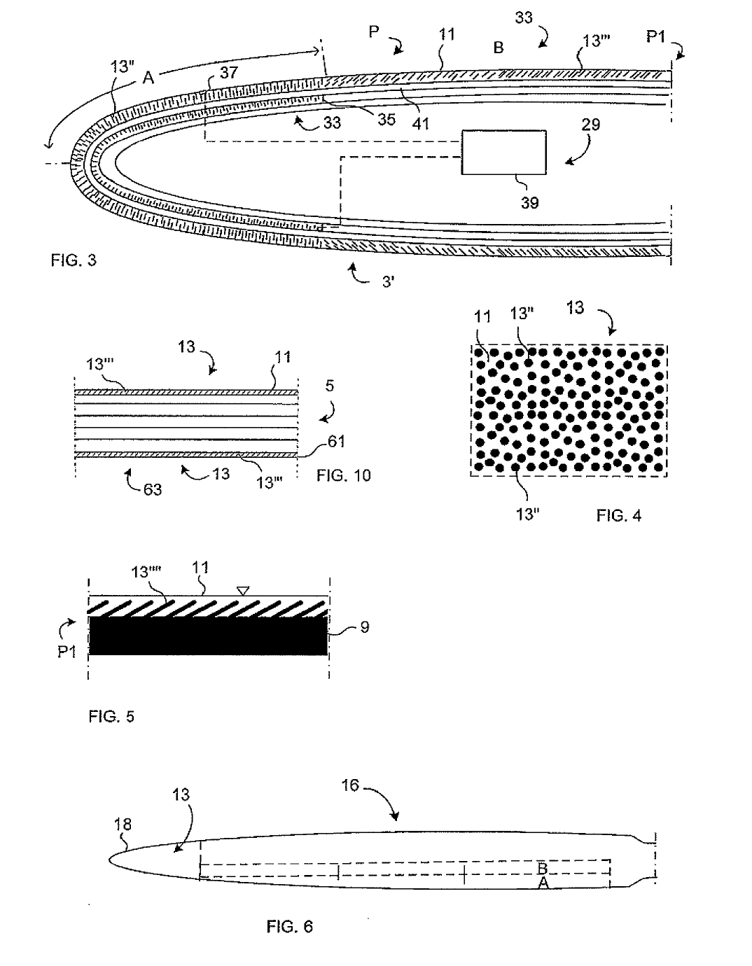

FIG. 3 schematically illustrates an example of a de-icing/anti-icing system 29 of a portion of a wind turbine blade shell 3′. The system 29 comprises a conductive structure serving as a heating element 35. The heating element 35 comprises a conductive nano structure 33 with such an orientation and density so that the electrical resistance increases for a current conducted through the heating element 35 thereby generating heat for melting or preventing ice to form. A sensor 37 is also arranged in the outer surface 11. When the sensor 37 detects the presence of ice, a signal is fed from the sensor 37 to a control unit 39, wherein the control unit 39 activates the heating element 35.

An outer ply P1, comprising the outer surface 11, is arranged over the heating element 35. Also the outer ply P1 comprises the same type of conductive nano structure 33 as the de-icing/ant-icing heating element 35. In area A for the outer ply P1, the nano structure filaments are transversely oriented partly exposed in the outer surface 11, whereby an optimal strength of the outer surface 11 is achieved. At the same time the nano structure 13, which also is conductive, will promote for a propagation of an eventual lightning strike current to a lightning conductor (not shown) protecting the de-icing/anti-icing system 29. The outer ply P1 is electrical isolated arranged in regard to the de-icing/ant-icing heating element 35 by means of an isolating layer 41. Due to the transversely oriented nano structure 13″ for area A in the outer ply P1 (acting as a lightning protection) also heat from the heating element 35 will be transferred thermally to the outer surface 11 in a path as short as possibly, thus concentrating the heat to area A, acting as an anti-icing section.

The leaning nano filaments 13′″ of the outer ply P1 for area B contributes to reinforcement in z-direction and promotes for good electric conductivity, beneficial for the lightning protection.

FIG. 4 schematically illustrates an enlarged view of a section of the outer surface 11 of the shell 3′ in FIG. 3 seen from above. In the FIG. 4 is clearly illustrated that the nano structure filaments 13″ (here nano fibres) are exposed in the outer surface 11, thus creating a hard and smooth aerodynamic surface.

FIG. 5 schematically illustrates a cross-section of leaning CNT's 13″″ grown as a “forests” directly extending from large fibres 9 of a laminate 5 comprising the upper ply P1. The CNT's 13″″ are produced by emerging CNT technology resulting in grown forests of CNT's for high efficiency. The CNT's 13″″ are thus grown in the shape of “forests” (mats of aligned CNT's) and the outer ply P1 consists of a single layer. The CNT's 13″″ have a very good thermal and electrical conductivity and are therefore very suited for the lightning protection covering for example a sensitive de-icing/anti-icing system, electrical system etc. By embedding the CNT's 13″″ in the upper ply P1 in such way that the orientation of the CNT's relative the outer surface 11 is unidirectional, the laminate can be effectively manufactured since a proper distribution of resin will be achieved. Thereby the aerodynamic surface will be hard, smooth and form stable.

FIG. 6 schematically illustrates a wind turbine blade 16. The speed of the article (wind turbine blade) is at the blade tip 18 from 80 m/s (normal) up to 120 m/s (maximum). Wind turbines having two blades will provide a speed at the blade tip about 120 m/s. The tips are thus generating most noise. There is a wish (for energy transport optimizing) to arrange wind power stations near population areas and by means of the present wind power blade a more silent station is provided. I.e. the smooth hard surface provides a silent power station and thus energy is saved as it can be placed near the buildings. As the tip has the highest speed the FIG. 6 wind turbine blade is provided with the outer surface, which serves as an aerodynamic surface when the article is subjected for an air stream, the article comprises a resin matrix made of a laminate of at least one ply, which comprises said outer surface. The outer ply within the area of the blade tip comprises the nano structure 13 embedded therein in such way that the filaments of the nano structure in the ply have the same orientation relative the plane of the outer surface.

By orienting the nano structure filaments in the laminate (for each ply) in essentially the same direction, the laminate can be effectively manufactured since a proper distribution of resin during the production of the laminate will be achieved. Thereby the aerodynamic surface will be hard, smooth and form stable. The smoothness of the wind turbine blade's outer surface 11 can thus be maintained over time. The smoothness promotes for a laminar flow over the outer surface 11, wherein the wind power station will be efficient. Furthermore, the outer surface 11 will not have the undesired roughness due to several contributing effects, e.g. cure shrinkage of the polymeric material during the curing of the laminate, uneven distribution of resin in the surface layer (resin-rich-areas) and therefore different thermal elongation of surface material etc. This will promote for a well-designed laminate of the wind turbine blade.

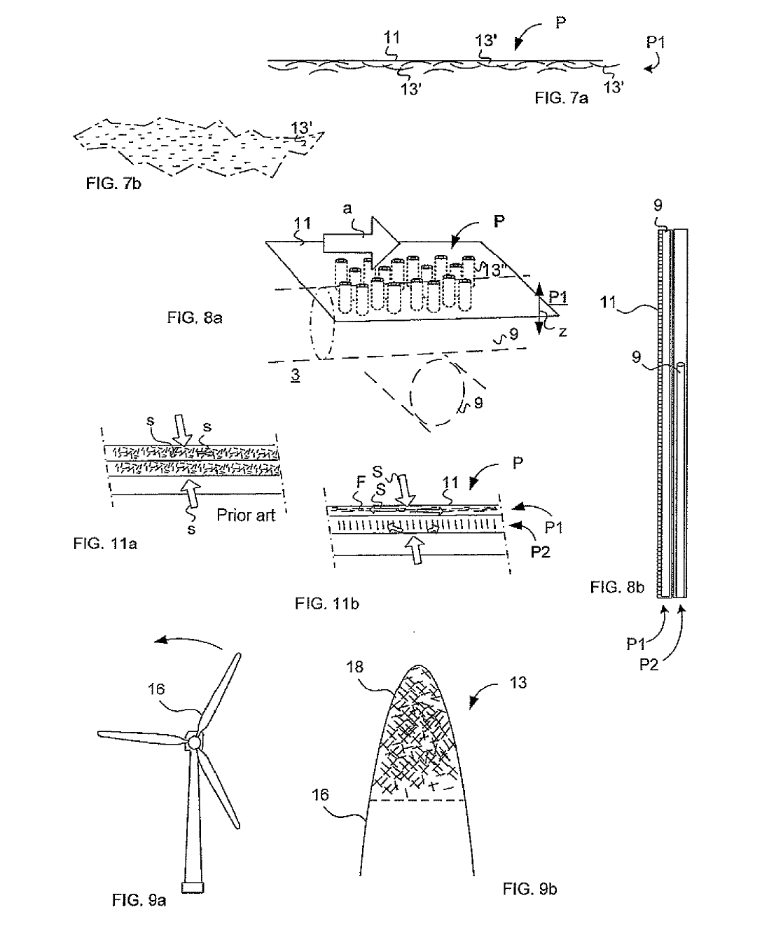

FIG. 7a schematically illustrates an outer surface 11 of a wind turbine blade comprising nano carbon fibres 13′ embedded in an upper layer (upper ply P1) of plastic. The upper layer is of the type shown in FIG. 2a with the carbon nano fibres essentially extending parallel with the plane P of the outer surface 11 (having the same orientation relative the plane P of the outer surface 11). The upper layer also being comprised of large carbon fibres (not shown) embedded in the plastic reinforcing the structure of the article (carbon fibre reinforced plastic (CFRP) structures). The carbon nano fibres 13′ are embedded in the plastic in such way that at least a portion of the carbon nano fibres 13′ are exposed in the outer surface 11, i.e. several carbon nano fibres 13′ are exposed in the outer surface 11 for making a hard outer surface, thus maintaining the smoothness of the outer surface 11 over long time for promoting a wind power station with high efficiency. The use of the nano carbon fibres 13′ for making a hard surface is thus compatible regarding the thermal elongation with the carbon fibre reinforced plastic (GFRP). FIG. 7b schematically illustrates the outer surface 11 in FIG. 7a from above, wherein is shown the partly exposed nano carbon fibres 13′.

FIG. 8a schematically shows a perspective view of transversally grown CNT's 13″ as a “forest” directly extending from large horizontal (parallel extension with the plane P of the outer surface) carbon fibres 9 of an upper ply P1. The CNT's 13″ are produced by emerging CNT technology resulting in grown forests of CNT. The vertical CNT's 13″ are well-defined and contribute also to a strengthening in z-direction, marked with z. FIG. 8b schematically shows a cross-section of the upper ply P1 in FIG. 8a. Also is shown in FIG. 8b a ply P2 with large carbon fibres 9 (of the GFRP) arranged beneath the upper ply P1, which fibres 9 are oriented 45 degrees relative the large carbon fibres' 9 orientation of the upper ply P1, serving as a substrate for the growing of the transversal carbon nano tubes 13″ during the production process.

FIG. 9a schematically illustrates a wind power station placed offshore. There is a wish to provide the wind turbine blades 16 with such material properties that the blades do not need frequent service and remount actions. The wind turbine blades 16 are of low weight due to the nano filament structures providing the hard outer surface of the turbine tips 18 shown in FIG. 9b.

FIG. 10 schematically illustrates a laminate 5 comprising the reinforced outer surface 11 and a nano structure reinforced layer 61 of the underside 63 of the laminate 5 for avoiding a so called spring back-effect during production of the laminate 5. During production of the laminate 5 a nano structure 13 thus will be applied also on the side of the laminate opposite the outer surface 11. This is made for preventing that residual stresses of the upper side of the laminate 5 buckle the laminate 5, i.e. compensating the applied nano structure 13 of the outer surface 11 with a proper amount of nano structure filaments 13′″ in the laminate's 5 underside 63 essentially corresponding with the amount of nano structure filaments 13′″ in the outer surface 11.

FIG. 11a schematically shows a portion of a laminate of a wind turbine blade according to prior art. Carbon nano tubes are randomly oriented in the upper ply. During manufacturing of the article the resin will be hindered to flow efficient into the spaces between the carbon nano tubes (illustrated with arrows s).

FIG. 11b schematically illustrates a portion of an embodiment of the present invention comprising a first upper ply P1 and a second ply P2 arranged beneath the upper ply P1. The both plies P1 and P2 include embedded nano filaments therein. The upper ply P1 comprises nano filaments F being applied as a mat onto the second ply P2. The mat is manufactured by a procedure similar to a production of ordinary paper. The nano filaments F are mixed with a liquid. The liquid are poured out and the remaining nano filaments F will form a mat of random oriented nano filaments (seen in a view from above and towards the plane of the mat). However, the mat will have nano filaments with their prolongations extended in a direction parallel with the plane of the mat, i.e. the extension of the nano filaments F will be essential parallel with the extension of the plane P of the outer surface 11. During the production of the laminate a resin used as a resin matrix will flow into the mat unhindered and will fill all spaces (arrows marked with S) between the nano filaments F, thus providing a hard and even (smooth) outer surface being form stable.

The present invention is of course not in any way restricted to the preferred embodiments described above, but many possibilities to modifications, or combinations of the described embodiments, thereof should be apparent to a person with ordinary skill in the art without departing from the basic idea of the invention as defined in the appended claims.

The nano structure filaments can be embedded in the upper ply in such way that a portion of the nano filaments is exposed in the outer surface. This means that a portion of the nano structure is exposed in the outer surface meaning that the filaments, including a first and second end, of that portion are exposed. They may thus expose their first ends in the outer surface.

A typical composite component such as a wind turbine blade and an integrated blade leading edge of CFRP or similar material could, as an example, be cured in a female tool. The invented surface layer (precured or uncured) can be placed in this tool before the curing operation to form the outer layer of the cured assembly. The CNT-reinforced surface layer can be integrated in the lay-up and curing of the composite airframe component. The CNT-reinforced surface layer can also be applied as a spray-on layer (e.g. by electro-static painting) or separately manufactured layer that is attached to the composite structure after curing.

The CNT's can be produced by emerging CNT technology resulting in grown forests of CNT for high efficiency. It is known that CNT's preferably are grown in the shape of “forests” (mats of aligned CNT's) with vertical, tilted or horizontally arranged nano tubes. Combinations of these arrangements are also possible, e.g. as two or more separate layers stacked on top of each other. It is also possible to grow CNT's as well-defined patterns, suited for the intended application. The term CNT is this application includes all types of carbon nano tubes. These can be single-wall, double-wall or multi-wall nano tubes. In addition, CNT-like materials like graphene, graphone and similar carbon-based materials with suitable electrical and thermal properties can be used. The composite of the outer ply/outer layer can be epoxy, polymides, bismaleimides, phenolics, cyanatester, PEEK, PPS, polyester, vinylester and other curable resins or mixtures thereof. If used, the large fibre structure may be of ceramic, carbon and metal or mixtures thereof.

Plies comprising the nano structure can be applied to the exterior of an existing, already manufactured and assembled airframe structure. The application can be made by means of adhesive bonding or co-cured or co-bonded on the wind turbine blade structure.

1. A wind turbine blade, comprising:
an outer surface, which serves as an aerodynamic surface when the blade is subjected for an air stream,
a resin matrix made of a laminate of at least one ply, which comprises said outer surface, wherein the outer ply comprises a nano structure embedded therein in such way that nano filaments of the nano structure in the ply essentially have the same angular orientation relative a plane of the outer surface.

2. The article according to claim 1, wherein at least a portion of the nano structure is exposed in the outer surface.

3. The article according to claim 1, wherein the outer ply is a ply of a laminate comprising at least two plies, wherein each ply comprises large fibers having an orientation different from or identical to the orientation of large fibers of an adjacent ply.

4. The article according to, wherein the nano structure is so dense within the ply so that the nano structure will be as hard as possible, but not so dense that the electric conductivity ceases.

5. The article according to, wherein filaments of the nano structure are oriented transverse to the plane of the outer surface.

6. The article according to claim 1, wherein filaments of the nano structure are oriented leaning relative the plane of the outer surface.

7. The article according to claim 1, wherein filaments of the nano structure are oriented parallel with the plane of the outer surface.

8. The article according to claim 1, wherein the nano structure comprises carbon nano tubes.

9. The article according to claim 8, wherein the carbon nano tubes are in a shape of forest mats of aligned carbon nano tubes.

10. The article according to claim 1, wherein the nano structure is positioned within the area of the blade tip.
